(19) United States
(12) Patent Application Publication
(10) Pub. No.: US 2026/0086415 A1
(43) Pub. Date: Mar. 26, 2026

(54) SEMICONDUCTOR DEVICE AND FABRICATING METHOD THEREOF

(71) Applicant: TAIWAN SEMICONDUCTOR MANUFACTURING COMPANY, LTD., Hsinchu (TW)

(72) Inventors: Tai-Chun HUANG, New Taipei City (TW); Stefan RUSU, Sunnyvale, CA (US)

(73) Assignee: TAIWAN SEMICONDUCTOR MANUFACTURING COMPANY, LTD., Hsinchu (TW)

(21) Appl. No.: 18/893,799

(22) Filed: Sep. 23, 2024

(51) Int. Cl. G02F 1/21; G02F 1/01; G02F 1/225

(52) U.S. Cl. CPC G02F 1/212; G02F 1/0121; G02F 1/2257; G02F 2202/06; G02F 2203/15

(57) ABSTRACT

A semiconductor device includes a first converter structure, a second converter structure and a first waveguide portion. The first converter structure is configured to modulate an optical light to generate a first modulated light. The second converter structure is configured to modulate the first modulated light to generate a second modulated light. The first waveguide portion is configured to transmit the first modulated light from the first converter structure to the second converter structure, and elongated along a first direction. The first converter structure, the first waveguide portion, and the second converter structure are arranged along the first direction in order.

### BACKGROUND

The integration of silicon photonics and electronic chips is commonly used in various integration applications. However, the large area of integration can cause significant energy loss, generating excessive heat, and reducing the efficiency and lifespan of the system. Moreover, traditional neural networks rely on the computing power of chips, but the computing speed and area are still limited, resulting in high levels of energy loss. The emergence of silicon photonics can effectively reduce energy loss and improve computing speed. However, photonic-electronic integration remains a challenging problem for most wafer fabs. In addition, deep neural network models have exponentially expanded, and general chip hardware capabilities are difficult to achieve, making silicon photonics an important research topic. However, the challenges faced by silicon photonics neural networks include lower optoelectronic conversion efficiency, low area utilization, and cross-talk problems, which currently prevent the effective improvement of computing efficiency.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram of a system illustrated in accordance with some embodiments of the present disclosure.

FIG. 1B is a schematic diagram of further details of the system shown in FIG. 1A, illustrated in accordance with some embodiments of the present disclosure.

FIG. 1C is a schematic diagram of further details of the PIC shown in FIG. 1A, illustrated in accordance with some embodiments of the present disclosure.

FIG. 2A is a layout diagram of a semiconductor device corresponding to the converters shown in FIG. 1A, illustrated in accordance with some embodiments of the present disclosure.

FIG. 2B is a cross section diagram of the semiconductor device along the line shown in FIG. 2A, illustrated in accordance with some embodiments of the present disclosure.

FIG. 2C is a cross section diagram of the semiconductor device along the line shown in FIG. 2A, illustrated in accordance with some embodiments of the present disclosure.

FIG. 2D is an alternative cross section diagram of the semiconductor device shown in FIG. 2A, illustrated in accordance with some embodiments of the present disclosure.

FIG. 3A is a schematic diagram of a PIC corresponding to the PIC shown in FIG. 1C, illustrated in accordance with some embodiments of the present disclosure.

FIG. 3B is a layout diagram of a semiconductor device corresponding to the PIC shown in FIG. 3A, illustrated in accordance with some embodiments of the present disclosure.

FIG. 4A is a schematic diagram of a PIC corresponding to the PIC shown in FIG. 3A, illustrated in accordance with some embodiments of the present disclosure.

FIG. 4B is a schematic diagram of a semiconductor device corresponding to the PIC shown in FIG. 4A, illustrated in accordance with some embodiments of the present disclosure.

FIG. 5A is a schematic diagram of a semiconductor device corresponding to the PIC shown in FIG. 1C, illustrated in accordance with some embodiments of the present disclosure.

FIG. 5B is a schematic diagram of a semiconductor device corresponding to the semiconductor device shown in FIG. 5A, illustrated in accordance with some embodiments of the present disclosure.

FIG. 5C is a schematic diagram of a semiconductor device corresponding to the semiconductor device shown in FIG. 5A, illustrated in accordance with some embodiments of the present disclosure.

FIG. 6 is a flowchart diagram of a method for fabricating the semiconductor devices described above, illustrated in accordance with some embodiments of the present disclosure.

FIG. 7 is a schematic view of a system for designing and manufacturing at least one of the semiconductor devices described above, illustrated in accordance with some embodiments of the present disclosure.

FIG. 8 is a block diagram of an integrated circuit (IC)/semiconductor device manufacturing system, and an IC manufacturing flow associated therewith, illustrated in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

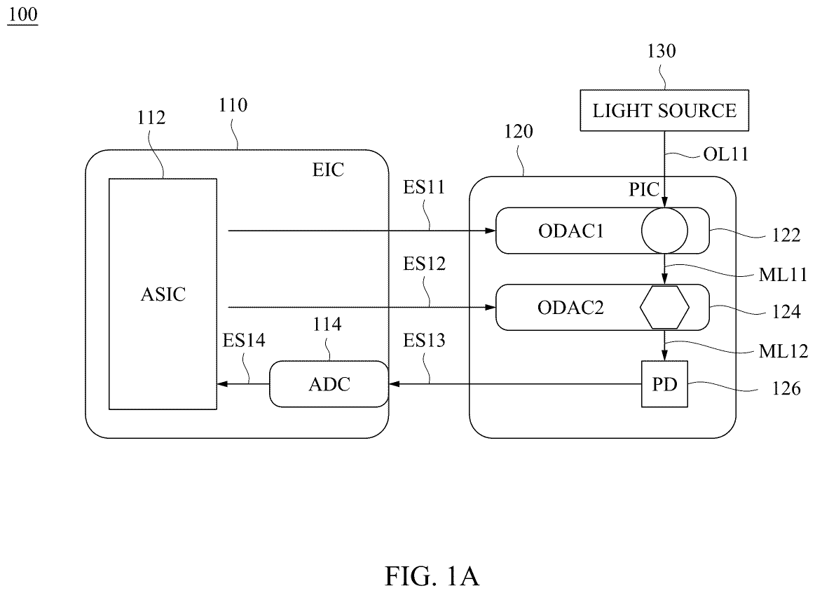

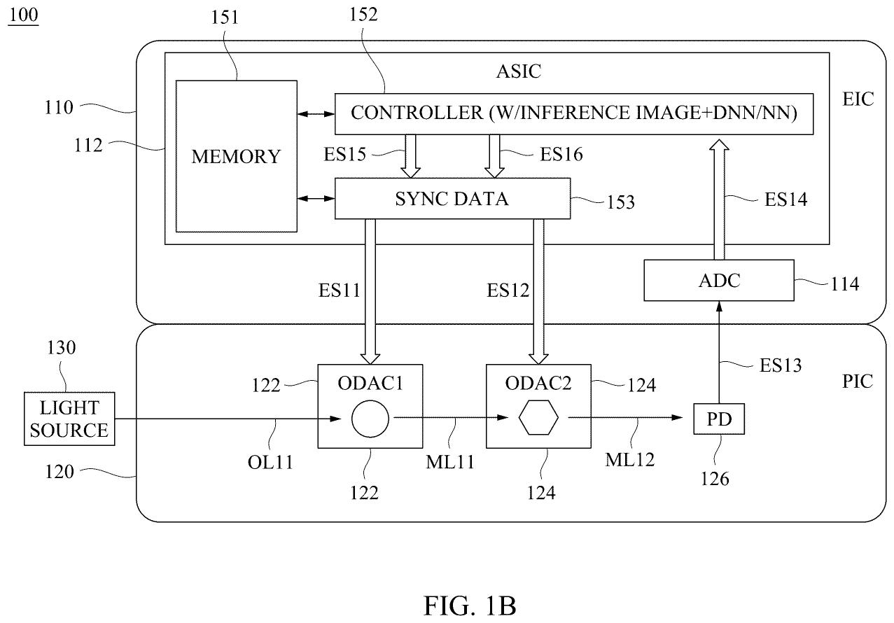

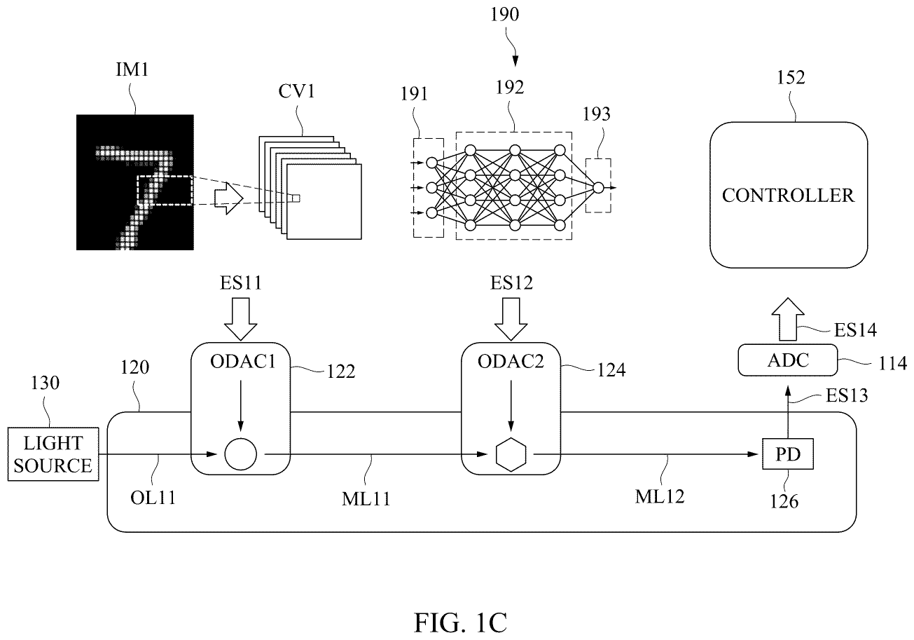

FIG. 1A is a schematic diagram of a system 100 illustrated in accordance with some embodiments of the present disclosure. As illustratively shown in FIG. 1A, the system 100 includes an electronic integrated circuit (EIC) 110, a photonic integrated circuit (PIC) 120 and a light source 130.

In some embodiments, the EIC 110 is configured to provide electrical signals ES11 and ES12 through corresponding electrical paths to the PIC 120. The light source 130 is configured to provide an optical light OL11 through a light path to the PIC 120. The PIC 120 is configured to generate an electrical signal ES13 according to the optical light OL11 and the electrical signals ES11 and ES12, and provide the electrical signal ES13 through an electrical path to the EIC 110. In some embodiments, the optical light OL11 is implemented by a single-wavelength laser.

As illustratively shown in FIG. 1A, the EIC 110 includes a circuit 112 and a converter 114. The circuit 112 is configured to generate the electrical signals ES11 and ES12, and receive an electrical signal ES14. The converter 114 is configured to convert the electrical signal ES13 to the electrical signal ES14.

In some embodiments, the circuit 112 and the converter 114 are implemented by an application specific integrated circuit (ASIC) and an analog-to-digital converter (ADC), respectively. The electrical signals ES13 and ES14 are an analog signal and a digital signal, respectively. In some embodiments, the converter 114 includes a transimpedance amplifier (TIA).

The PIC 120 includes converters 122, 124 and a photodetector 126. The converter 122 is configured to modulate the optical light OL11 according to the electrical signal ES11, to generate a modulated light ML11. The converter 124 is configured to modulate the modulated light ML11 according to the electrical signal ES12, to generate a modulated light ML12. The photodetector 126 is configured to detect the modulated light ML12 to generate the electrical signal ES13. In some embodiments, each of the converters 122 and 124 are implemented by optical digital-to-analog converters (ODAC).

In some embodiments, the converters 122 and 124 operate as a deep neural network (DNN) architecture, such as a DNN 190 shown in FIG. 1C. The electrical signal ES11 and the modulated light ML11 correspond to an input data, such as an input image. The electrical signal ES12 corresponds to weighting parameters. Alternatively stated, the converter 124 processes the input data according to the weighting parameters to generate the modulated light ML12, which corresponds to the probability output of the DNN.

In some embodiments, with the DNN architecture, compute in memory (CIM) operations are performed with the system 100. CIM technology performs computations in memory, which greatly improves processing speed, reduces energy consumption, and enhances data privacy. The basic principle of CIM is to store computation data in memory and perform computations directly in memory, eliminating the transfer time of data from memory to the processor. CIM technology has been widely applied in fields such as artificial intelligence, big data, and high-performance computing, providing new solutions for accelerating processing speed.

In some approaches, digital-to-analog converters provide electronic signals to a photonic integrated circuit for modulating optical light. The digital-to-analog converters are integrated in an electronic integrated circuit, such that extra components and areas are required.

Compared to above approaches, the converters 122 and 124 are integrated in the PIC for modulating optical light. As a result, costs and area are saved space by eliminating the need for additional electro-optic modulation and transmission components, leading to increased speed, efficiency, accuracy, and robustness. Furthermore, system performance, stability, and reliability are improved, while reducing errors and noise from optical components.

FIG. 1B is a schematic diagram of further details of the system 100 shown in FIG. 1A, illustrated in accordance with some embodiments of the present disclosure. As illustratively shown in FIG. 1B, the circuit 112 includes a memory 151, a controller 152 and a synchronize circuit 153.

In some embodiments, the memory 151 is configured to store the input data and the weighting parameters of the DNN or a neural network (NN). The controller 152 is configured to generate electrical signals ES15 and ES16 corresponding to the input data and the weighting parameters, respectively, to control the synchronize circuit 153. The synchronize circuit 153 is configured to synchronize the electrical signals ES11 and ES12 according to the electrical signals ES15 and ES16. In some embodiments, the input data corresponds to an inference image.

FIG. 1C is a schematic diagram of further details of the PIC 120 shown in FIG. 1A, illustrated in accordance with some embodiments of the present disclosure. As illustratively shown in FIG. 1C, the electrical signal ES11 corresponds to an input image IM1 and convolutions CV1 of the input image IM1. The DNN 190 includes multiple fully connected layers, such as an input layer 191, an output layer 193 and hidden layers 192 between the input layer 191 and the output layer 193.

In some embodiments, the converters 122 and 124 correspond to the input layer 191 and the hidden layers 192, respectively. The photodetector 126 corresponds to the output layer 193. For example, the converter 122 receives the electrical signal ES11 corresponding to the input layer 191 to modulate the optical light OL11. The converter 124 receives the electrical signal ES12 corresponding to the weighting parameters of the hidden layers 192 to modulate the modulated light ML11. The photodetector 126 receives the modulated light ML12 corresponding to the output layer 193.

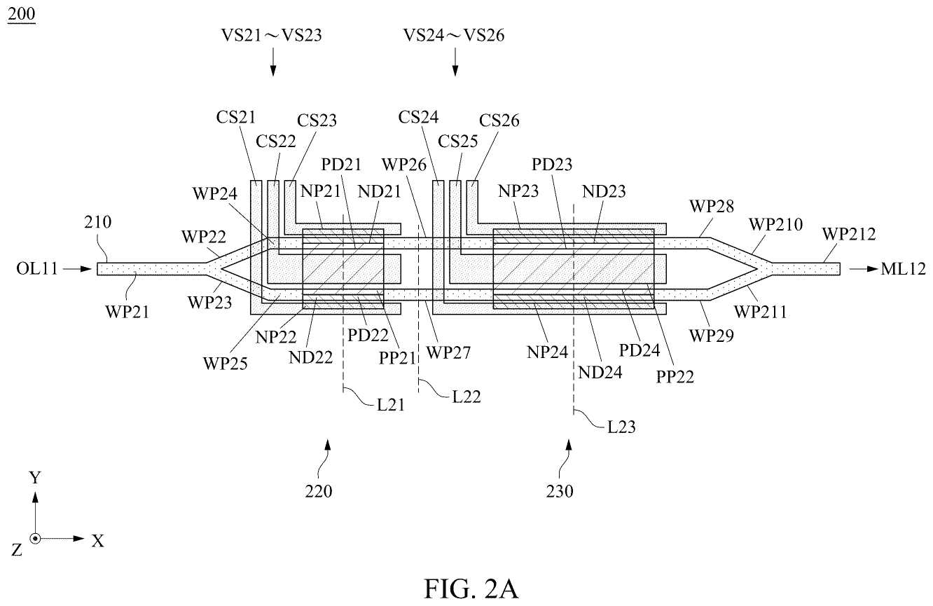

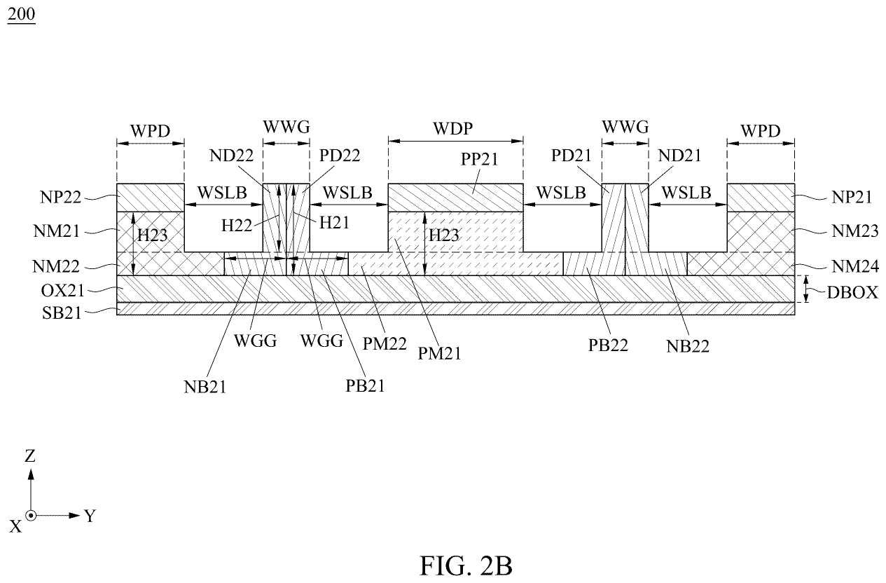

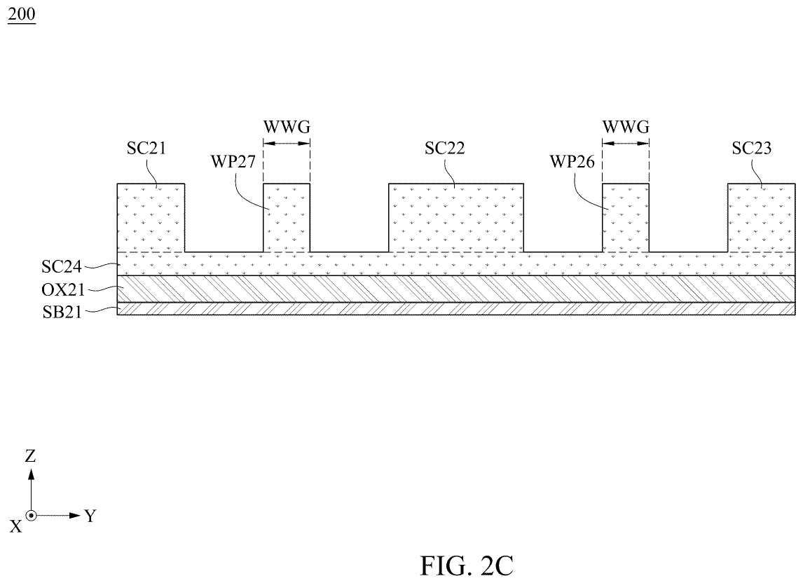

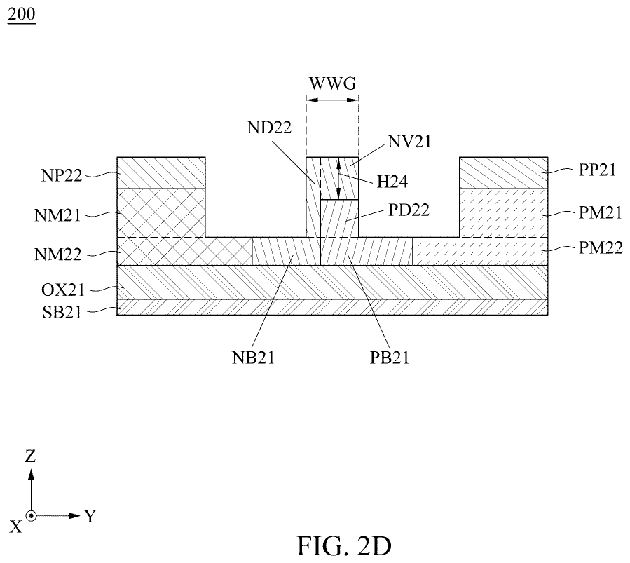

FIG. 2A is a layout diagram of a semiconductor device 200 corresponding to the converters 122 and 124 shown in FIG. 1A, illustrated in accordance with some embodiments of the present disclosure. As illustratively shown in FIG. 2A, the semiconductor device 200 includes a waveguide structure 210, converter structures 220, 230, and conductive segments CS21-CS26. Each of the converter structures 220 and 230 is integrated with the waveguide structure 210.

In some embodiments, the converter structures 220 and 230 are implemented by Mach Zehnder inferometers (MZM), and referred to as a photonic neural network (PNN) plus ODAC architecture. In some embodiments, the waveguide structure 210 is implemented by silicon or silicon nitride, such as Si₃N₄.

In some embodiments, the waveguide structure 210 is configured to transmit the optical light OL11 along the X direction, and output the modulated light ML12. The conductive segments CS21-CS23 are configured to apply the voltage signals VS21-VS23 to the converter structure 220. The converter structure 220 is configured to modulate the optical light OL11 according to the voltage signals VS21-VS23, to output the modulated light ML11. The conductive segments CS24-CS26 are configured to apply the voltage signals VS24-VS26 to the converter structure 230. The converter structure 230 is configured to modulate the modulated light ML11 according to the voltage signals VS24-VS26, to output the modulated light ML12.

Referring to FIG. 1A and FIG. 2A, the voltage signals VS21-VS23 are embodiments of the electrical signals ES11. The voltage signals VS24-VS26 are embodiments of the electrical signals ES12. The converter 122 is implemented by the converter structure 220. The converter 124 is implemented by the converter structure 230.

In some embodiments, each of the voltage signals VS22 and VS24 has a ground voltage level. The voltage levels of the voltage signals VS23 and VS21 correspond to two input bits of the input data, respectively. The voltage levels of the voltage signals VS24 and VS26 correspond to two of the weighting parameters, respectively.

As illustratively shown in FIG. 2A, each of the converter structures 220 and 230 is elongated along an X direction. In the embodiment shown in FIG. 2A, along the X direction, a length of the converter structure 230 is larger than a length of the converter structure 220. The waveguide structure 210 includes waveguide portions WP21-WP212. Each of the waveguide portions WP21, WP24-WP29, WP212 is elongated along the X direction.

In some embodiments, the waveguide portion WP22 is elongated along a first inclined direction which is different from each of the X direction and the Y direction. The waveguide portion WP23 is elongated along a second inclined direction which is different from each of the X direction, the Y direction and the first inclined direction. In some embodiments, the waveguide portions WP211 and WP210 are elongated along the first inclined direction and the second inclined direction, respectively.

The converter structure 220 includes doped portions NP21, ND21, PD21, PP21, PD22, ND22 and NP22 arranged in order along a Y direction. The converter structure 230 includes doped portions NP23, ND23, PD23, PP22, PD24, ND24 and NP24 arranged in order along the Y direction.

In the embodiment shown in FIG. 2A, a Z direction points out from the paper. In some embodiments, the X direction, the Y direction and the Z direction are perpendicular with each other. Along the Z direction, the conductive segments VS21-VS26 are overlapped with and coupled to the doped portions NP22, PP21, NP21, NP24, PP22 and NP23, respectively. Accordingly, the doped portions NP22, PP21, NP21, NP24, PP22 and NP23 are configured to receive the voltage signals VS21-VS26, respectively.

Along the X direction, each of the doped portions ND21 and PD21 is disposed between and coupled to the waveguide portions WP24 and WP26. Each of the doped portions ND22 and PD22 is disposed between and coupled to the waveguide portions WP23 and WP27. Each of the doped portions ND23 and PD23 is disposed between and coupled to the waveguide portions WP26 and WP28. Each of the doped portions ND24 and PD24 is disposed between and coupled to the waveguide portions WP27 and WP29.

During operation, the optical light OL11 passes through two light paths. The first light path is formed by the waveguide portions WP21, WP22, WP24, WP26, WP28, WP210, WP212 and the doped portions ND21, PD21, ND23, PD23. The second light path is formed by the waveguide portions WP21, WP23, WP25, WP27, WP29, WP211, WP212 and the doped portions ND22, PD22, ND24, PD24. In some embodiments, the doped portions ND21-ND24 and PD21-PD24 are referred to as part of the waveguide structure 210. Alternatively stated, the waveguide structure 210 and the converter structures 220, 230 are integrated with each other.

As illustratively shown in FIG. 2A, the waveguide portion WP22 is coupled to and disposed between the waveguide portions WP21 and WP24. The waveguide portion WP23 is coupled to and disposed between the waveguide portions WP21 and WP25. The waveguide portion WP210 is coupled to and disposed between the waveguide portions WP28 and WP212. The waveguide portion WP211 is coupled to and disposed between the waveguide portions WP29 and WP212.

Referring to FIG. 1A and FIG. 2A, the doped portions PD21 and ND21 are configured to receive the optical light OL11, and modulate the optical light OL11 according to the voltage difference between the voltage signals CS22 and CS23, to generate the modulated light ML11. The waveguide portion WP26 is configured to transmit the modulated light ML11 from the doped portions PD21 and ND21 to the doped portions PD23 and ND23. The doped portions PD23 and ND23 are configured to modulate the modulated light ML11 according to the voltage difference between the voltage signals CS25 and CS26, to generate the modulated light ML12.

Similarly, the doped portions PD22 and ND22 are configured to receive the optical light OL11, and modulate the optical light OL11 according to the voltage difference between the voltage signals CS22 and CS21, to generate the modulated light ML11. The waveguide portion WP27 is configured to transmit the modulated light ML11 from the doped portions PD22 and ND22 to the doped portions PD24 and ND24. The doped portions PD24 and ND24 are configured to modulate the modulated light ML11 according to the voltage difference between the voltage signals CS25 and CS24, to generate the modulated light ML12.

In some embodiments, in response to the voltage levels of the voltage signals CS21 and CS23 being different from each other, the modulated light ML11 in the waveguide portion WP26 is different from the modulated light ML11 in the waveguide portion WP27.

In some embodiments, lengths of the waveguide portions WP22 and WP23 are the same. In other embodiments, the lengths of the waveguide portions WP22 and WP23 are different from each other. For example, the waveguide portion WP22 has a length L, and the waveguide portion WP22 has a length L+ΔL. The length ΔL is referred to as a light path difference between the first light path and the second light path.

In response to the length ΔL being larger than zero, lengths of the first light path and the second light path are different from each other, such that the waveguide portion WP212 outputs the modulated light ML12 having periodic energy. In some embodiments, the length ΔL can also be positioned at the waveguide portions WP28 and WP29. For example, the waveguide portions WP28 and WP29 have the lengths L and L+ΔL, respectively.

As illustratively shown in FIG. 2A, the waveguide portions WP26 and WP27 are separated from each other along the Y direction. Alternatively stated, the waveguide portions WP26 and WP27 remain to be split from each other along the Y direction, from the converter structure 220 to the converter structure 230. The waveguide portion WP26 includes two opposite edges each extends along the X direction. The waveguide portion WP27 also includes two opposite edges each extends along the X direction. Each of lengths of the edges of the waveguide portions WP26 and WP27 is approximately equal to a distance between the converter structures 220 and 230.

FIG. 2B is a cross section diagram of the semiconductor device 200 along the line L21 shown in FIG. 2A, illustrated in accordance with some embodiments of the present disclosure. As illustratively shown in FIG. 2B, the semiconductor device 200 further includes doped portions NM21-NM24, NB21, PB21, PM21, PM22, PB22, NB22, an oxide portion OX21 and a substrate SB21.

Along the Z direction, each of the doped portions NM21-NM24, NB21, PB21, PM21, PM22, PB22 and NB22 is disposed above the oxide portion OX21, the oxide portion OX21 is disposed above the substrate SB21. The doped portions NP22, ND22, PD22, PP21, PD21, ND21 and NP21 are disposed above and coupled to the doped portions NM21, NB21, PB21, PM21, PB22, NB22 and NM23, respectively. The doped portions NM21, PM21 and NM23 are disposed above and coupled to the doped portions NM22, PM22 and NM24, respectively.

Along the Y direction, the doped portions NM22, NB21, PB21, PM22, PB22, NB22 and NM24 are arranged in order. Each of the doped portions NP22 and NP21 has a width WPD. The doped portion PP21 has a width WDP. The doped portions NP22 and ND22 are separated from each other by a width WSLB. The doped portions PD22 and PP21 are separated from each other by the width WSLB. The doped portions PD21 and PP21 are separated from each other by the width WSLB. The doped portions ND21 and NP21 are separated from each other by the width WSLB. Each of the doped portions NB21, PB21, PB22 and NB22 has a width WGG.

In some embodiments, the width WWG is within a range of 0.2 micrometer to 2 micrometer. The width WSLB is within a range of 0.2 micrometer to 2 micrometer. The width WPD is within a range of 0.2 micrometer to 10 micrometer. The width WDP is approximately equal to the width WPD multiplied by two. The width WGG is within a range of the width WWG multiplied by 50% to 200%.

Along the Z direction, each of the doped portions ND22, PD22, PD21 and ND21 has a height H22. A height H21 is between the oxide portion OX21 and each of the top edges of the doped portions ND22, PD22, PD21 and ND21. A height H23 is between the oxide portion OX21 and each of the top edges of the doped portions NM21, PM21 and NM23. The oxide portion OX21 has a height DBOX.

In some embodiments, the height H21 is within a range of 0.1 micrometer to 5 micrometer. The height H22 is within a range of 0.05 micrometer to 4.5 micrometer. The height DBOX is within a range of 0.1 micrometer to 5 micrometer. The height H23 is within a range of the height H21 multiplied by 50% to 95%.

In some embodiments, the substrate SB21 is implemented by silicon. The oxide portion OX21 is formed by silicon dioxide. Each of the doped portions NP22, NM21-NM24, ND22, ND21 and NP21 is implemented by silicon doped with N-type carriers. A density of the N-type carriers of each of the doped portions NP21 and NP22 is within a range of 10¹⁸ to 10²⁰ per centimeter cubic. A density of the N-type carriers of each of the doped portions ND21 and ND22 is within a range of 10¹⁴ to 10¹⁶ per centimeter cubic. A density of the N-type carriers of each of the doped portions NM21-NM24 is within a range of 10¹⁶ to 10¹⁸ per centimeter cubic.

In some embodiments, each of the doped portions PD22, PP21, PM21, PM22 and PD21 is implemented by silicon doped with P-type carriers. A density of the P-type carriers of the doped portion PP21 is within a range of 10¹⁸ to 10²⁰ per centimeter cubic. A density of the P-type carriers of each of the doped portions PD21 and PD22 is within a range of 10¹⁴ to 10¹⁶ per centimeter cubic. A density of the P-type carriers of each of the doped portions PM21 and PM22 is within a range of 10¹⁶ to 10¹⁸ per centimeter cubic.

Referring to FIG. 2A and FIG. 2B, along the line L23, the converter structure 230 has a cross sectional architecture similar with the cross sectional architecture of the converter structure 220 as shown in FIG. 2B. The doped portions NP24, ND24, PD24, PP22, PD23, ND23 and NP23 correspond to the doped portions NP22, ND22, PD22, PP21, PD21, ND21 and NP21 shown in FIG. 2B, respectively. For brevity, some descriptions are not repeated.

FIG. 2C is a cross section diagram of the semiconductor device 200 along the line L22 shown in FIG. 2A, illustrated in accordance with some embodiments of the present disclosure. As illustratively shown in FIG. 2C, the semiconductor device 200 further includes silicon portions SC21-SC24.

Along the Z direction, the silicon portion SC24 is disposed above the oxide portion OX21, and each of the silicon portions SC21-SC23 and the waveguide portions WP27, WP26 are disposed above the silicon portion SC24.

Along the Y direction, the silicon portion SC21, the waveguide portion WP27, the silicon portion SC22, the waveguide portion WP26 and the silicon portion SC23 are arranged in order and are separated from each other. Each of the waveguide portions WP26 and WP27 has the width WWG.

Referring to FIG. 2A to FIG. 2C, along the X direction, the waveguide portion WP27 contacts each of the doped portions ND22 and PD22, and the waveguide portion WP26 contacts each of the doped portions ND21 and PD21. The silicon portions SC21-SC23 contact with the doped portions NP22, PP21 and NP21, respectively. A distance between the waveguide portions WP26 and WP27 is approximately equal to a distance between the doped portions PD22 and PD21.

In some embodiments, the silicon portions SC21-SC23 and the waveguide portions WP27, WP26 are implemented by the same material, such as silicon or silicon nitride. In some embodiments, the substrate SB21 is also implemented by silicon. Alternatively stated, in some embodiments, the substrate SB21 and the waveguide portions WP27, WP26 are implemented by the same material.

FIG. 2D is an alternative cross section diagram of the semiconductor device 200 shown in FIG. 2A, illustrated in accordance with some embodiments of the present disclosure. Referring to FIG. 2B and FIG. 2D, the semiconductor device 200 shown in FIG. 2D is an alternative embodiment of the semiconductor device 200 shown in FIG. 2B. FIG. 2D follows a similar labeling convention to that of FIG. 2B. For brevity, the discussion will focus more on differences between FIG. 2D and FIG. 2B than on similarities.

Compared to the semiconductor device 200 shown in FIG. 2B, the semiconductor device 200 shown in FIG. 2D further includes a doped portion NV21, and the doped portion PD22 is shorter than the doped portion ND22 along the Z direction.

Along the Z direction, the doped portion NV21 is disposed above and coupled to the doped portion PD22, and has a height H24. Along the Y direction, the doped portion NV21 is coupled to the doped portion ND22. In some embodiments, the doped portions NV21 and ND22 are implemented by same material. In some embodiments, the height H24 is within a range of 0.05 micrometer to 2.5 micrometer.

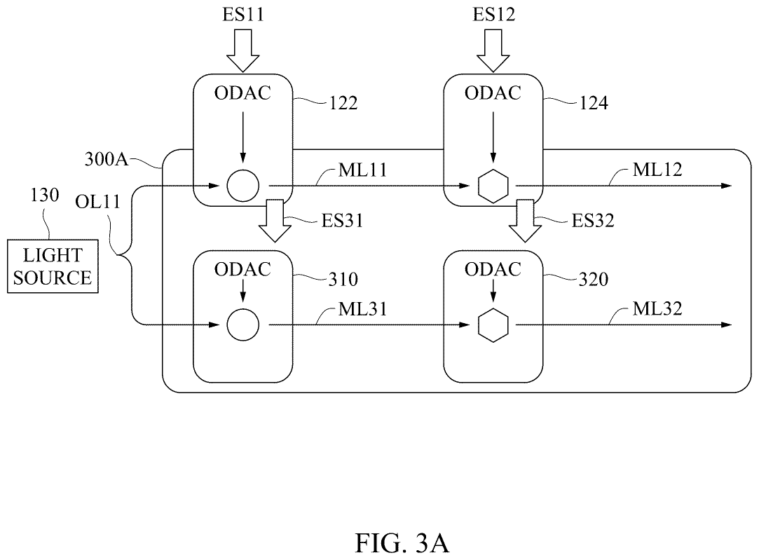

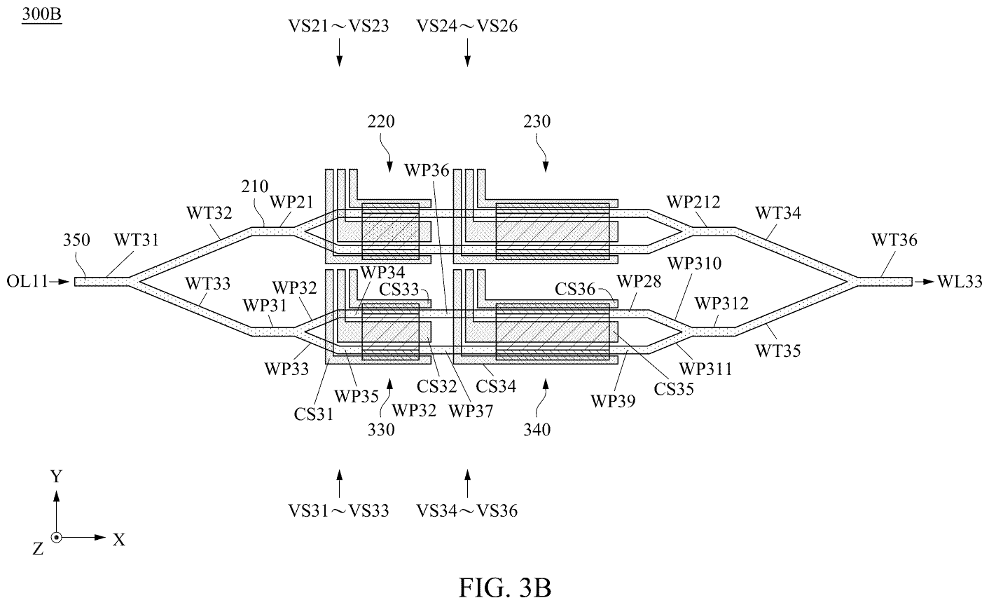

FIG. 3A is a schematic diagram of a PIC 300A corresponding to the PIC 120 shown in FIG. 1C, illustrated in accordance with some embodiments of the present disclosure. Referring to FIG. 3A and FIG. 1C, the PIC 300A is an alternative embodiment of the PIC 120. FIG. 3A follows a similar labeling convention to that of FIG. 1C. For brevity, the discussion will focus more on differences between FIG. 3A and FIG. 1C than on similarities.

Compared to the PIC 120, the PIC 300A further includes converters 310 and 320. Features of the converters 310 and 320 are similar with the converters 122 and 124. Therefore, some descriptions are not repeated for brevity.

As illustratively shown in FIG. 2A, the converter 310 is configured to modulate the optical light OL11 according to an electrical signal ES31, to generate a modulated light ML31. The converter 320 is configured to modulate the modulated light ML31 according to an electrical signal ES32, to generate a modulated light ML32. In some embodiments, each of the converters 310 and 320 are implemented by ODAC.

In some embodiments, the modulated lights ML12 and ML32 are combined to each other to generate a modulated light, such as the modulated light ML33 shown in FIG. 3B. In some embodiments, the photodetector (PD) 126 shown in FIG. 1C is further configured to detect the modulated light ML33 to generate a corresponding electrical signal.

FIG. 3B is a layout diagram of a semiconductor device 300B corresponding to the PIC 300A shown in FIG. 3A, illustrated in accordance with some embodiments of the present disclosure. Referring to FIG. 3B and FIG. 2A, the semiconductor device 300B is an alternative embodiment of the semiconductor device 200. FIG. 3B follows a similar labeling convention to that of FIG. 2A. For brevity, the discussion will focus more on differences between FIG. 3B and FIG. 2A than on similarities, and some labels in FIG. 2A are not shown in FIG. 3B.

Compared to the semiconductor device 200, the semiconductor device 300B further includes a waveguide structure 350, converter structures 330, 340 and conductive segments VS31-VS36. The waveguide structure 350 includes the waveguide structure 210 and waveguide portions WP31-WP312, WT31-WT36.

In some embodiments, the waveguide structure 350 is configured to transmit the optical light OL11 along the X direction. The conductive segments VS31-VS33 are configured to apply the voltage signals VS31-VS33, respectively, to the converter structure 330. The converter structure 330 is configured to modulate the optical light OL11 according to the voltage signals VS21-VS23, to output the modulated light ML31. The conductive segments VS34-VS36 are configured to apply the voltage signals VS34-VS36, respectively, to the converter structure 340. The converter structure 340 is configured to modulate the modulated light ML31 according to the voltage signals VS24-VS26, to output the modulated light ML32. The waveguide structure 350 is configured to combine the modulated lights ML12 and ML32 to output the modulated light ML33.

Referring to FIG. 3A and FIG. 3B, the voltage signals VS31-VS33 are embodiments of the electrical signals ES31. The voltage signals VS34-VS36 are embodiments of the electrical signals ES32. The converter 310 is implemented by the converter structure 330. The converter 320 is implemented by the converter structure 340.

In some embodiments, each of the voltage signals VS32 and VS34 has a ground voltage level. The voltage levels of the voltage signals VS33 and VS31 correspond to two input bits of the input data, respectively. The voltage levels of the voltage signals VS34 and VS36 correspond to two of the weighting parameters, respectively. The voltage signals VS21, VS23, VS31 and VS33 correspond to four input bits of the input data. The voltage signals VS24, VS26, VS34 and VS36 correspond to four weighting parameters. Accordingly, the semiconductor device 300B is configured modulate the optical light OL11 according to the four input bits and the four weighting parameters.

As illustratively shown in FIG. 3B, the optical light OL11 is transmitted through the waveguide portions WT31, WT32 and WP21 in order, and is transmitted through the waveguide portions WT31, WT33 and WP31 in order. The modulated light ML12 is transmitted through the waveguide portions WP212, WT34 and WT36 in order. The modulated light ML32 is transmitted through the waveguide portions WP312, WT35 and WT36 in order. The modulated lights ML12 and ML32 are combined in the waveguide portion WT36 to generate the modulated light ML33.

The converter structures 330 and 340 are similar with the converter structures 220 and 230, respectively. Therefore, some descriptions are not repeated for brevity. For example, each of the converter structures 220 and 230 has a cross sectional architecture shown in FIG. 2B.

The waveguide portions WP31-WP312 are similar with the waveguide portions WP21-WP212, respectively. Therefore, some descriptions are not repeated for brevity. For example, the converter structure 330 is configured to output the modulated light M31 to the waveguide portions WP36 and WP37. The waveguide portions WP36 and WP37 are configured to transmit the modulated light M31 to the converter structure 340. the waveguide portions WP36 and WP37 are separated from each other along the Y direction. The waveguide portion WP36 includes two edges each extends along the X direction. The waveguide portion WP37 also includes two edges each extends along the X direction. Each of lengths of the edges of the waveguide portions WP36 and WP37 is approximately equal to a distance between the converter structures 330 and 340.

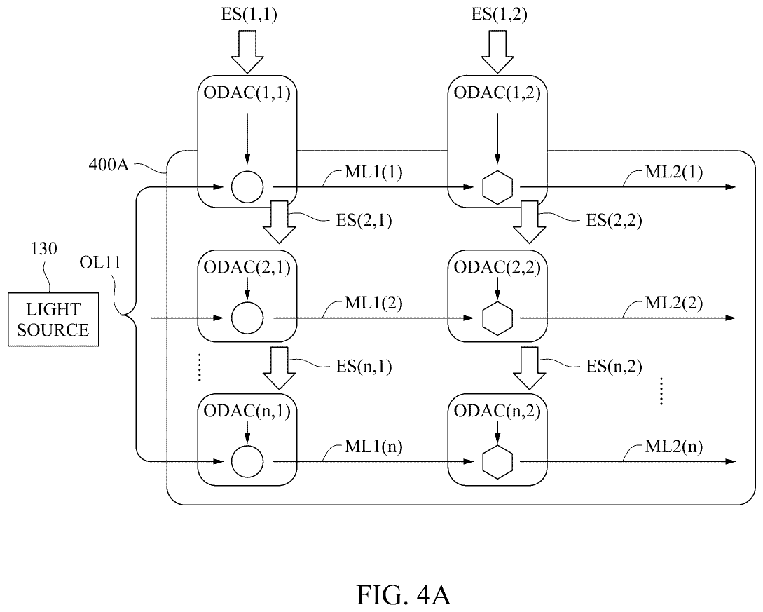

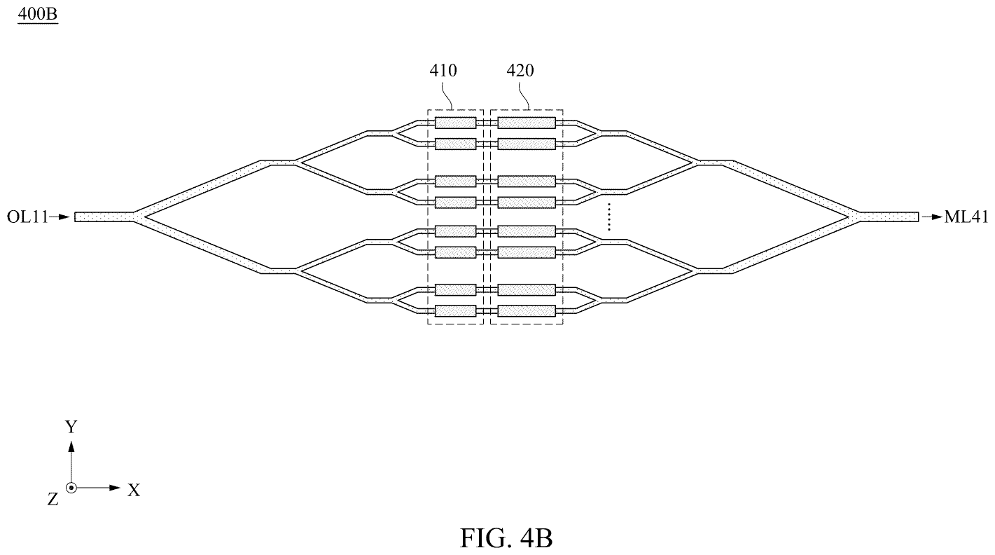

FIG. 4A is a schematic diagram of a PIC 400A corresponding to the PIC 300A shown in FIG. 3A, illustrated in accordance with some embodiments of the present disclosure. As illustratively shown in FIG. 4A, the PIC 400A includes converters ODAC(1, 1)-ODAC(n, 1) and ODAC(1, 2)-ODAC(n, 2), for n being a positive integer.

The converters ODAC(1, 1)-ODAC(n, 1) are configured to modulate the optical light OL11 according to the electrical signals ES(1, 1)-ES(n, 1), respectively, to generate modulated light ML1(1)-ML1(n). The converters ODAC(1, 2)-ODAC(n, 2) are configured to modulate the modulated light ML1(1)-ML1(n) according to the electrical signals ES(1, 2)-ES(n, 2), respectively, to generate modulated light ML2(1)-ML2(n).

Referring to FIG. 4A and FIG. 3A, the PIC 400A is an alternative embodiment of the PIC 300A. For example, the converters ODAC(1, 1), ODAC(2, 1), ODAC(1, 2) and ODAC(2, 2) are implemented by the converters 122, 310, 124 and 320, respectively. The modulated lights ML1(1), ML1(2), ML2(1) and ML2(2) correspond to the modulated lights ML11, ML31, ML12 and ML32, respectively.

FIG. 4B is a schematic diagram of a semiconductor device 400B corresponding to the PIC 400A shown in FIG. 4A, illustrated in accordance with some embodiments of the present disclosure. As illustratively shown in FIG. 4B, the semiconductor device 400B includes converter structure groups 410 and 420 arranged in order along the X direction. Each of converter structure groups 410 and 420 includes multiple converter structure.

In some embodiments, the converter structure group 410 is configured to modulate the optical light OL11 according to multiple input bits, to generate multiple modulated lights. The converter structure group 420 is configured to modulate the modulated lights outputted from the converter structure group 410 according to multiple weighting parameters, to generate multiple modulated lights. The multiple modulated lights outputted from the converter structure group 420 are combined as a modulated light ML41. In some embodiments, a quantity of the input bits is 2ⁿ, and a quantity of the weighting parameters is 2ⁿ. Accordingly, the semiconductor device 400B is configured to modulate optical light OL11 according to the 2ⁿ input bits and the 2ⁿ weighting parameters to generate the modulated light ML41.

Referring to FIG. 3B and FIG. 4B, in some embodiments, each of the converter structures in the converter structure group 410 is similar with the converter structure 220. Each of the converter structures in the converter structure group 420 is similar with the converter structure 230. Therefore, some descriptions are not repeated for brevity. In some embodiments, the converter structures 220 and 330 are included in the converter structure group 410, and the converter structures 230 and 340 are included in the converter structure group 420.

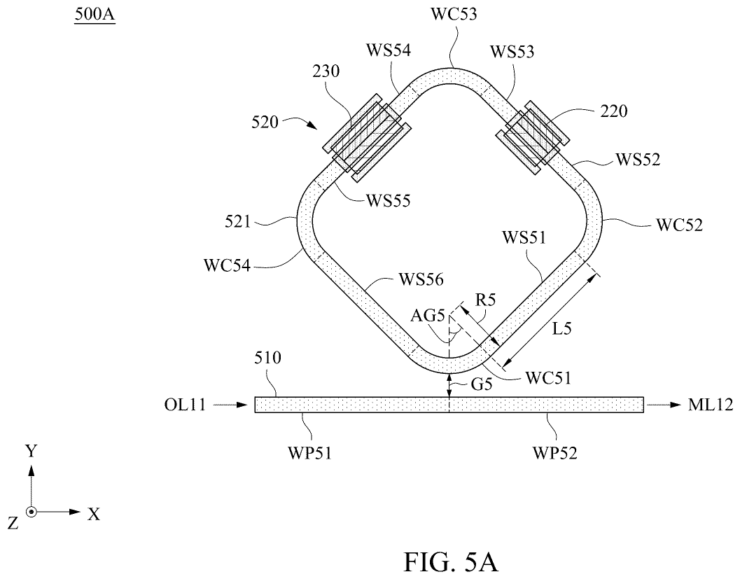

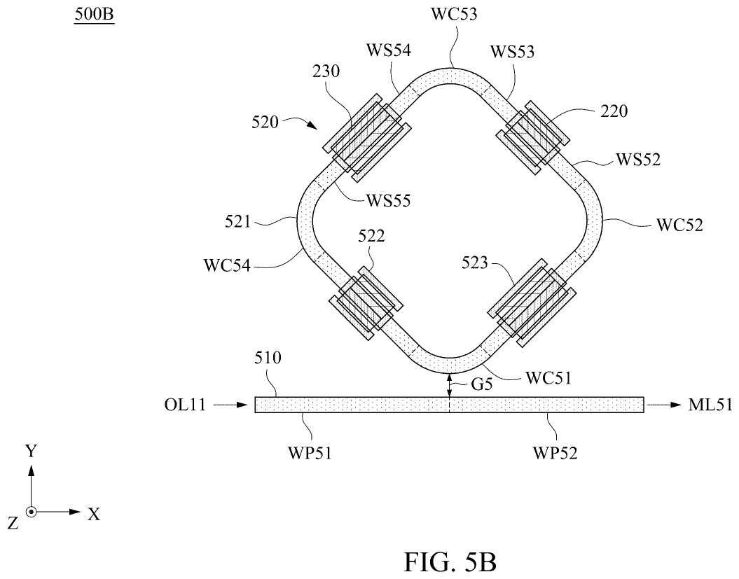

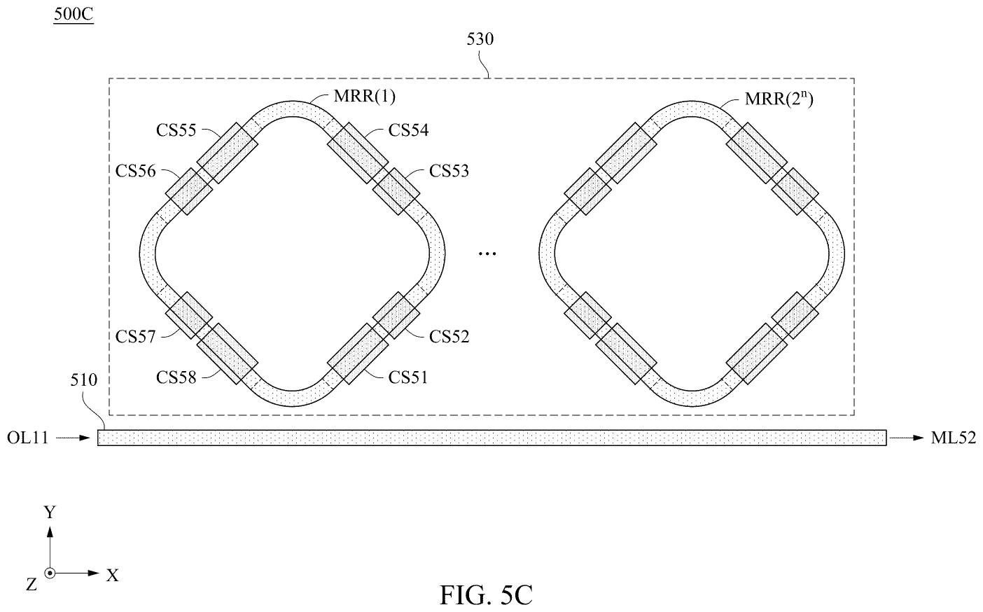

FIG. 5A is a schematic diagram of a semiconductor device 500A corresponding to the PIC 120 shown in FIG. 1C, illustrated in accordance with some embodiments of the present disclosure. As illustratively shown in FIG. 5A, the semiconductor device 500A includes a waveguide structure 510 and a resonator 520. The converter structures 220, 230 and waveguide structures 510, 520. In some embodiments, the converter structures 220, 230 and the waveguide structure 520 is referred to as a micro-ring resonator (MRR).

The waveguide structure 510 includes waveguide portions WP51 and WP52. The waveguide structure 520 includes waveguide portions WC51-WC54 and WS51-WS56. The waveguide portions WP51 and WP52 are coupled to each other and elongated along the X direction. Two terminals of the waveguide portion WC51 are coupled to the waveguide portions WS51 and WS56, respectively. Two terminals of the waveguide portion WC52 are coupled to the waveguide portions WS51 and WS52, respectively. Two terminals of the converter structure 220 are coupled to the waveguide portions WS52 and WS53, respectively. Two terminals of the waveguide portion WC53 are coupled to the waveguide portions WS53 and WS54, respectively. Two terminals of the converter structure 230 are coupled to the waveguide portions WS54 and WS55, respectively. Two terminals of the waveguide portion WC54 are coupled to the waveguide portions WS55 and WS56, respectively. Referring to FIG. 2A and FIG. 5A, details of the converter structures 220 and 230 are described above in the embodiment associated with FIG. 2A. Therefore, some descriptions are not repeated for brevity.

In some embodiments, each of the waveguide portions WC51-WC54 has a curved shape. Specifically, the waveguide portions WC51-WC54 can be considered as four parts of a circle with a radius R5. A radian from a terminal of the waveguide portion WC51 to a middle of the waveguide portion WC51 corresponds to an angle AG5. The waveguide portion WC53 is symmetric to the waveguide portion WC51. In some embodiments, the angle AG5 is within a range of 45 degree to 90 degree, and the radius R5 is within a range of 2.5 micrometer to 50 micrometer.

In some embodiments, each of the waveguide portions WS51, WS54 and WS55 elongated along a first inclined direction, and each of the waveguide portions WS56, WS52 and WS53 elongated along a second inclined direction different from the first inclined direction. Each of the waveguide portions WS51 and WS56 has a length L5. In some embodiments, a summation of lengths of the waveguide portions WS52, WS53 and the converter structure 220 is equal to the length L5, and a summation of lengths of the waveguide portions WS55, WS54 and the converter structure 230 is also equal to the length L5.

As illustratively shown in FIG. 5A, the middle of the waveguide portion WC51 is separated from the waveguide structure 510 by a distance G5 along the Y direction. In some embodiments, the distance G5 is with a range of 0.05 micrometer to 1 micrometer.

During operation, the optical light OL11 is transmitted from the waveguide portion WP51 to the middle of the waveguide portion WC51. Then, the optical light OL11 is transmitted through the waveguide portions WC51, WS51, WC52 and WS52 in order, to the converter structure 220. The converter structure 220 is configured to modulate the optical light OL11 to generate the modulated light ML11.

Then, the modulated light ML11 is transmitted from the converter structure 220, through the waveguide portions WS53, WC53 and WS54 in order, to the converter structure 230. The converter structure 230 is configured to modulate the modulated light ML11 to generate the modulated light ML12.

Then, the modulated light ML12 is transmitted from the converter structure 230, through the waveguide portions WS55, WC54 and WS56 in order, to the middle of the waveguide portion WC51. Then, the modulated light ML12 is transmitted from is transmitted from the middle of the waveguide portion WC51 to the waveguide portion WP52. The waveguide portion WP52 outputs the modulated light ML12.

FIG. 5B is a schematic diagram of a semiconductor device 500B corresponding to the semiconductor device 500A shown in FIG. 5A, illustrated in accordance with some embodiments of the present disclosure. Referring to FIG. 5B and FIG. 5A, the semiconductor device 500B is an alternative embodiment of the semiconductor device 500A. FIG. 5B follows a similar labeling convention to that of FIG. 5A. For brevity, the discussion will focus more on differences between FIG. 5B and FIG. 5A than on similarities.

Compared to the semiconductor device 500A, the semiconductor device 500B further includes converter structures 522 and 523. The converter structures 522 and 523 are included in the resonator 520. During operation, the converter structures 522, 220, 230 and 523 modulate the optical light OL11 in order, to generate the modulated light ML51. Accordingly, the waveguide structure 510 receives the modulated light ML51 from the resonator 520 and outputs the modulated light ML51.

Referring to FIG. 3A and FIG. 5B, in some embodiments, the converter structures 220, 230, 522 and 523 are configured to receive the electrical signals ES11, ES12, ES31 and ES32, respectively. Accordingly, the resonator 520 modulates the optical light OL11 according to four input bits and four weighting parameters.

FIG. 5C is a schematic diagram of a semiconductor device 500C corresponding to the semiconductor device 500A shown in FIG. 5A, illustrated in accordance with some embodiments of the present disclosure. As illustratively shown in FIG. 5C, the semiconductor device 500C includes the waveguide structure 510 and a resonator group 530. The resonator group 530 includes multiple resonators.

In some embodiments, the waveguide structure 510 is configured to transmit the optical light OL11 to the resonator group 530. The resonators in the resonator group 530 are configured to modulate the optical light OL11 in order to generate a modulated light ML52, and transmit the modulated light ML52 to the waveguide structure 530, such that the waveguide structure 530 outputs the modulated light ML52.

In some embodiments, a quantity of the resonators in the resonator group 530 is 2ⁿ. In the embodiment shown in FIG. 5C, the resonator group 530 includes resonators MRR(1)-MRR(2ⁿ) arranged in order along the X direction. Accordingly, the semiconductor device 500C is configured to modulate optical light OL11 according to the 2ⁿ input bits and the 2ⁿ weighting parameters to generate the modulated light ML52.

Referring to FIG. 5A and FIG. 5C, in some embodiments, each of the resonators MRR(1)-MRR(2ⁿ) in the resonator group 530 is similar with the resonator 520. In some embodiments, the resonator MRR(1) is implemented by the resonator 520. However, the embodiments of present disclosure are not limited to this. In various embodiments, each of the resonators includes various quantities of converter structures. In the embodiment shown in FIG. 5C, the each of the resonators in the resonator group 530 includes eight converter structures.

For example, the resonator MRR(1) includes converter structures VS51-VS58. The converter structures VS51-VS58 are configured to modulate the optical light OL11 in order. Each of the converter structures CS51, CS52, CS55 and CS56 is elongated along the first inclined direction, and each the of the converter structures CS53, CS54, CS57 and CS58 is elongated along the second inclined direction. In some embodiments, each of the resonators MRR(2)-MRR(2ⁿ) is similar with the resonator MRR(1). Accordingly, some descriptions are not repeated for brevity.

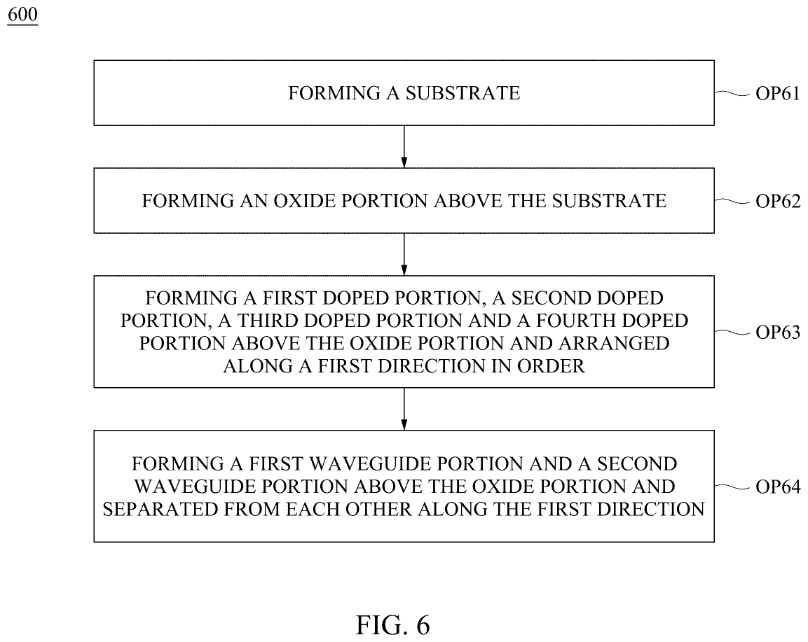

FIG. 6 is a flowchart diagram of a method 600 for fabricating the semiconductor devices described above, illustrated in accordance with some embodiments of the present disclosure. The method 600 includes operations OP61-OP64.

During the operation OP61, a substrate is formed. For example, the substrate SB21 shown in FIG. 2B is formed.

During the operation OP62, an oxide portion is formed above the substrate. For example, the oxide portion OX21 is formed above the substrate SB21.

During the operation OP63, a first doped portion, a second doped portion, a third doped portion and a fourth doped portion are formed above the oxide portion and are arranged along a first direction in order. For example, the doped portions ND22, PD22, PD21 and ND21 are formed above the oxide portion OX21 and arranged along the Y direction in order.

During the operation OP64, a first waveguide portion and a second waveguide portion are formed above the oxide portion and separated from each other along the first direction. For example, the waveguide portions WP27 and WP26 shown in FIG. 2C are formed above the oxide portion OX21 and are separated from each other along the Y direction.

In some embodiments, the first waveguide portion is coupled to each of the first doped portion and the second doped portion, the second waveguide portion is coupled to each of the third doped portion and the fourth doped portion, each of the first doped portion and the fourth doped portion has a first conductive type, and each of the second doped portion and the third doped portion has a second conductive type different from the first conductive type.

For example, the waveguide portion WP27 is coupled to each of the doped portions ND22 and PD22. The waveguide portion WP26 is coupled to each of the doped portions PD21 and ND21. Each of the doped portions ND22 and ND21 has a conductive type of N-type carriers. Each of the doped portions PD22 and PD21 has a conductive type of P-type carriers.

In some embodiments, the method 600 further includes forming a fifth doped portion between and separated from the second doped portion and the third doped portion, and forming a silicon portion between and separated from the first waveguide portion and the second waveguide portion. The fifth doped portion contacts the silicon portion.

For example, the doped portion PP21 is formed between and separated from the doped portions PD22 and PD21. The silicon portion SC22 is formed between and separated from the waveguide portions WP27 and WP26. The doped portion PP21 contacts the silicon portion SC22.

In some embodiments, the silicon portion, the first waveguide portion and the second waveguide portion are the same material. For example, the silicon portion SC22 and the waveguide portions WP27 and WP26 are formed by silicon or silicon nitride.

In some embodiments, the fifth doped portion has the second conductive type and has a first carrier density, and each of the second doped portion and the third doped portion has a second carrier density lower than the first carrier density. For example, the doped portion PP21 has the conductive type of P-type carriers and has the carrier density within the range of 10¹⁸ to 10²⁰ per centimeter cubic. Each of the doped portions PD22 and PD21 has the carrier density within the range of 10¹⁴ to 10¹⁶ per centimeter cubic.

In some embodiments, the method 600 further includes forming a fifth doped portion above the second doped portion and has the first conductive type. The fifth doped portion is coupled to each of the first doped portion and the second doped portion.

For example, the doped portion NV21 shown in FIG. 2D is formed above the doped portion PD22 and has the conductive type of N-type carriers. The doped portion NV21 is coupled to each of the doped portions ND22 and PD22.

In some embodiments, the first doped portion, the second doped portion, the third doped portion and the fourth doped portion are included in a first converter structure, the first waveguide portion and the second waveguide portion are coupled between the first converter structure and a second converter structure, and each of two opposite edges of the first waveguide portion has a length approximately equal to a distance between the first converter structure are the second converter structure.

For example, the doped portions ND22, PD22, PD21 and ND21 are included in the converter structure 220. The waveguide portions WP26 and WP27 are coupled between the converter structures 220 and 230. Each of two opposite edges of the waveguide portion WP27 has a length approximately equal to a distance between the converter structures 220 and 230.

In some embodiments, a distance between the first waveguide portion and the second waveguide portion is approximately equal to a distance between the second doped portion and the third doped portion. For example, a distance between the waveguide portion WP27 and WP26 is approximately equal to a distance between the doped portions PD22 and PD21. Referring to FIG. 2B, the distance between the doped portions PD22 and PD21 is equal to the width WDP plus the width WSLB multiplied by two.

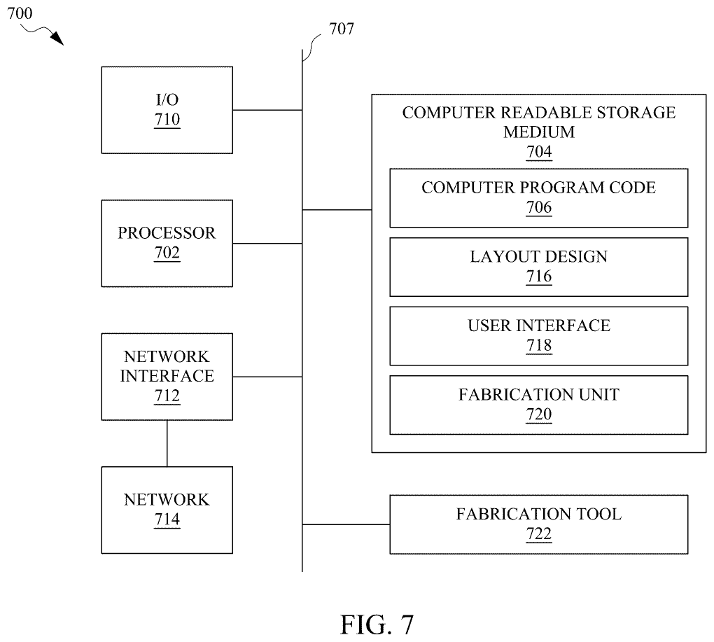

FIG. 7 is a schematic view of a system 700 for designing and manufacturing at least one of the semiconductor devices described above, illustrated in accordance with some embodiments of the present disclosure. The system 700 generates or places one or more IC layout designs corresponding to at least one of the semiconductor devices described above, as described herein. In some embodiments, the system 700 manufactures one or more semiconductor devices based on the one or more IC layout designs, as described herein. The system 700 includes a hardware processor 702 and a non-transitory, computer readable storage medium 704 encoded with, e.g., storing, the computer program code 706, e.g., a set of executable instructions. The computer readable storage medium 704 is configured for interfacing with manufacturing machines for producing the semiconductor device. The processor 702 is electrically coupled to the computer readable storage medium 704 by a bus 707. The processor 702 is also electrically coupled to an I/O interface 710 by the bus 707. A network interface 712 is also electrically connected to the processor 702 by the bus 707. Network interface 712 is connected to a network 714, so that the processor 702 and the computer readable storage medium 704 are capable of connecting to external elements via network 714. The processor 702 is configured to execute the computer program code 706 encoded in the computer readable storage medium 704 in order to cause the system 700 designing and manufacturing at least one of the semiconductor devices described above.

In some embodiments, the processor 702 is a central processing unit (CPU), a multi-processor, a distributed processing system, an application specific integrated circuit (ASIC), and/or a suitable processing unit.

In some embodiments, the computer readable storage medium 704 is an electronic, magnetic, optical, electromagnetic, infrared, and/or a semiconductor system (or apparatus or device). For example, the computer readable storage medium 704 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 704 includes a compact disk-read only memory (CD-ROM), a compact disk-read/write (CD-R/W), and/or a digital video disc (DVD).

In some embodiments, the storage medium 704 also stores information needed for designing and manufacturing at least one of the semiconductor devices described above, such as layout design 716, user interface 717, fabrication unit 720, and/or a set of executable instructions to designing and manufacturing at least one of the semiconductor devices described above.

In some embodiments, the storage medium 704 stores instructions (e.g., the computer program code 706) for interfacing with manufacturing machines. The instructions (e.g., the computer program code 706) enable the processor 702 to generate manufacturing instructions readable by the manufacturing machines to effectively implement the semiconductor devices described above.

The system 700 includes the I/O interface 710. The I/O interface 710 is coupled to external circuitry. In some embodiments, the I/O interface 710 includes a keyboard, keypad, mouse, trackball, trackpad, and/or cursor direction keys for communicating information and commands to the processor 702.

The system 700 also includes the network interface 712 coupled to the processor 702. The network interface 712 allows the system 700 to communicate with the network 714, to which one or more other computer systems are connected. The network interface 712 includes wireless network interfaces such as BLUETOOTH, WIFI, WIMAX, GPRS, or WCDMA; or wired network interface such as ETHERNET, USB, or IEEE-13154. In some embodiments, the designing and manufacturing of at least one of the semiconductor devices described above is implemented in two or more systems 700, and information such as layout design, user interface and fabrication unit are exchanged between different systems 700 by the network 714.

The system 700 is configured to receive information related to a layout design through the I/O interface 710 or network interface 712. The information is transferred to the processor 702 by the bus 707 to determine a layout design for producing an IC. The layout design is then stored in the computer readable medium 704 as the layout design 716. The system 700 is configured to receive information related to a user interface through the I/O interface 710 or network interface 712. The information is stored in the computer readable medium 704 as the user interface 717. The system 700 is configured to receive information related to a fabrication unit through the I/O interface 710 or network interface 712. The information is stored in the computer readable medium 704 as the fabrication unit 720. In some embodiments, the fabrication unit 720 includes fabrication information utilized by the system 700.

In some embodiments, the designing and manufacturing of at least one of the semiconductor devices described above is implemented as a standalone software application for execution by a processor. In some embodiments, the designing and manufacturing of at least one of the semiconductor devices described above is implemented as a software application that is a part of an additional software application. In some embodiments, the designing and manufacturing of at least one of the semiconductor devices described above is implemented as a plug-in to a software application. In some embodiments, the designing and manufacturing of at least one of the semiconductor devices described above is implemented as a software application that is a portion of an EDA tool. In some embodiments, the designing and manufacturing of at least one of the semiconductor devices described above is implemented as a software application that is used by an EDA tool. In some embodiments, the EDA tool is used to generate a layout design of the integrated circuit device. In some embodiments, the layout design is stored on a non-transitory computer readable medium. In some embodiments, the layout design is generated using a tool such as VIRTUOSO® available from CADENCE DESIGN SYSTEMS, Inc., or another suitable layout generating tool. In some embodiments, the layout design is generated based on a netlist which is created based on the schematic design. In some embodiments, at least one of the semiconductor devices described above is implemented by a manufacturing device to manufacture an integrated circuit using a set of masks manufactured based on one or more layout designs generated by the system 700. In some embodiments, the system 700 includes a manufacturing device (e.g., fabrication tool 722) to manufacture an integrated circuit using a set of masks manufactured based on one or more layout designs of the present disclosure.

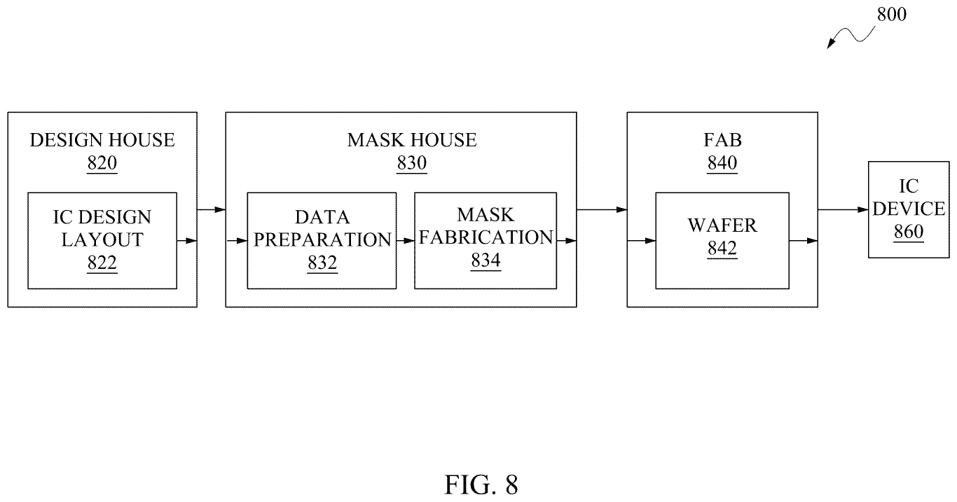

FIG. 8 is a block diagram of an integrated circuit (IC)/semiconductor device manufacturing system 800, and an IC manufacturing flow associated therewith, illustrated in accordance with some embodiments of the present disclosure.

In FIG. 8, the IC manufacturing system 800 includes entities, such as a design house 820, a mask house 830, and an IC manufacturer/fabricator (“fab”) 840, that interact with one another in the design, development, and manufacturing cycles and/or services related to manufacturing an IC device (semiconductor device) 860 including at least one of the semiconductor devices described above. The entities in system 800 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 820, mask house 830, and IC fab 840 is owned by a single company. In some embodiments, two or more of design house 820, mask house 830, and IC fab 840 coexist in a common facility and use common resources.

The design house (or design team) 820 generates an IC design layout 822. The IC design layout 822 includes various geometrical patterns designed for the IC device 860. The geometrical patterns correspond to patterns of metal, oxide, or semiconductor layers that make up the various components of the IC device 860 to be fabricated. The various layers combine to form various IC features. For example, a portion of the IC design layout 822 includes various IC features, such as an active region, gate structures, source/drain structures, interconnect structures, and openings for bonding pads, to be formed in a semiconductor substrate (such as a silicon wafer) and various material layers disposed on the semiconductor substrate. The design house 820 implements a proper design procedure to form the IC design layout 822. The design procedure includes one or more of logic design, physical design or place and route. The IC design layout 822 is presented in one or more data files having information of the geometrical patterns. For example, the IC design layout 822 can be expressed in a GDSII file format or DFII file format.

The mask house 830 includes mask data preparation 832 and mask fabrication 834. The mask house 830 uses the IC design layout 822 to manufacture one or more masks to be used for fabricating the various layers of the IC device 860 according to the IC design layout 822. The mask house 830 performs the mask data preparation 832, where the IC design layout 822 is translated into a representative data file (“RDF”). The mask data preparation 832 provides the RDF to the mask fabrication 834. The mask fabrication 834 includes a mask writer. A mask writer converts the RDF to an image on a substrate, such as a mask (reticle) or a semiconductor wafer, or a metal layer which is formed and thereafter selectively etched to form a redistribution layer at a back end of line process of the fab. The design layout is manipulated by the mask data preparation 832 to comply with particular characteristics of the mask writer and/or requirements of the IC fab 840. In FIG. 8, the mask data preparation 832 and mask fabrication 834 are illustrated as separate elements. In some embodiments, the mask data preparation 832 and mask fabrication 834 can be collectively referred to as mask data preparation.

In some embodiments, the mask data preparation 832 includes optical proximity correction (OPC) which uses lithography enhancement techniques to compensate for image errors, such as those that can arise from diffraction, interference, other process effects and the like. OPC adjusts the IC design layout 822. In some embodiments, the mask data preparation 832 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, the mask data preparation 832 includes a mask rule checker (MRC) that checks the IC design layout that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout to compensate for limitations during the mask fabrication 834, which may undo part of the modifications performed by OPC in order to meet mask creation rules.

In some embodiments, the mask data preparation 832 includes lithography process checking (LPC) that simulates processing that will be implemented by the IC fab 840 to fabricate the IC device 860. LPC simulates this processing based on the IC design layout 822 to create a simulated manufactured device, such as the IC device 860. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC can be repeated to further refine the IC design layout 822.

It should be understood that the above description of the mask data preparation 832 has been simplified for the purposes of clarity. In some embodiments, the mask data preparation 832 includes additional features such as a logic operation (LOP) to modify the IC design layout according to manufacturing rules. Additionally, the processes applied to the IC design layout 822 during the mask data preparation 832 may be executed in a variety of different orders.

After the mask data preparation 832 and during mask fabrication 834, a mask or a group of masks are fabricated based on the modified IC design layout. In some embodiments, an electron-beam (e-beam) or a mechanism of multiple e-beams is used to form a pattern on a mask (photomask or reticle) based on the modified IC design layout. The mask can be formed in various technologies. In some embodiments, the mask is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask includes a transparent substrate (e.g., fused quartz) and an opaque material (e.g., chromium) coated in the opaque regions of the mask. In another example, the mask is formed using a phase shift technology. In the phase shift mask (PSM), various features in the pattern formed on the mask are configured to have proper phase difference to enhance the resolution and imaging quality. In various examples, the phase shift mask can be attenuated PSM or alternating PSM. The mask(s) generated by the mask fabrication 834 is used in a variety of processes. For example, such a mask(s) is used in an ion implantation process to form various doped regions in the semiconductor wafer, in an etching process to form various etching regions in the semiconductor wafer, and/or in other suitable processes.

The IC fab 840 is an IC fabrication entity that includes one or more manufacturing facilities for the fabrication of a variety of different IC products. In some embodiments, the IC fab 840 is a semiconductor foundry. For example, there may be a first manufacturing facility for the front end fabrication of a plurality of IC products (e.g., source/drain structures, gate structures), while a second manufacturing facility may provide the middle end fabrication for the interconnection of the IC products (e.g., MDs, VDs, VGs) and a third manufacturing facility may provide the back end fabrication for the interconnection and packaging of the IC products (e.g., M0 tracks, M1 tracks, BM0 tracks, BM1 tracks), and a fourth manufacturing facility may provide other services for the foundry entity.

The IC fab 840 uses the mask (or masks) fabricated by the mask house 830 to fabricate the IC device 860. Thus, the IC fab 840 at least indirectly uses the IC design layout 822 to fabricate the IC device 860. In some embodiments, a semiconductor wafer is fabricated by the IC fab 840 using the mask (or masks) to form the IC device 860. The semiconductor wafer 842 includes a silicon substrate or other proper substrate having material layers formed thereon. Semiconductor wafer further includes one or more of various doped regions, dielectric features, multilevel interconnects, and the like (formed at subsequent manufacturing steps).

Also disclosed is a semiconductor device. The semiconductor device includes a first converter structure, a second converter structure and a first waveguide portion. The first converter structure is configured to modulate an optical light to generate a first modulated light. The second converter structure is configured to modulate the first modulated light to generate a second modulated light. The first waveguide portion is configured to transmit the first modulated light from the first converter structure to the second converter structure, and elongated along a first direction. The first converter structure, the first waveguide portion, and the second converter structure are arranged along the first direction in order.

Also disclosed is a method. The method includes: forming a substrate; forming an oxide portion above the substrate; forming a first doped portion, a second doped portion, a third doped portion and a fourth doped portion above the oxide portion and arranged along a first direction in order; and forming a first waveguide portion and a second waveguide portion above the oxide portion and separated from each other along the first direction. The first waveguide portion is coupled to each of the first doped portion and the second doped portion, the second waveguide portion is coupled to each of the third doped portion and the fourth doped portion, each of the first doped portion and the fourth doped portion has a first conductive type, and each of the second doped portion and the third doped portion has a second conductive type different from the first conductive type.

Also disclosed is a semiconductor device. The semiconductor device includes a resonator and a waveguide structure. The resonator is configured modulate an optical light to generate a first modulated light. The waveguide structure is configured to transmit the optical light to the resonator, and configured to output the first modulated light. The resonator includes: at least one first converter structure configured to modulate the optical light to generate a second modulated light; and at least one second converter structure configured to modulate the second modulated light to generate the first modulated light.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor device, comprising:
a first converter structure configured to modulate an optical light to generate a first modulated light;
a second converter structure configured to modulate the first modulated light to generate a second modulated light;
a first waveguide portion configured to transmit the first modulated light from the first converter structure to the second converter structure, and elongated along a first direction; and
a second waveguide portion configured to transmit the first modulated light from the first converter structure to the second converter structure, and split from the first waveguide portion,
wherein the first converter structure, the first waveguide portion, and the second converter structure are arranged along the first direction in order.

2. The semiconductor device of claim 1, wherein the second waveguide portion is elongated along the first direction.

3. The semiconductor device of claim 1, wherein each of two opposite edges of the first waveguide portion has a length approximately equal to a distance between the first converter structure and the second converter structure along the first direction.

4. The semiconductor device of claim 1, wherein the first converter structure comprises:
a first doped portion having a first conductive type; and
a second doped portion coupled to the first doped portion and having a second conductive type different from the first conductive type,
wherein each of the first doped portion and the second doped portion are coupled to the first waveguide portion.

5. The semiconductor device of claim 4, wherein the first converter structure further comprises:
a third doped portion having the first conductive type; and
a fourth doped portion coupled to the third doped portion and having the second conductive type,
wherein the second waveguide portion is coupled to each of the third doped portion and the fourth doped portion.

6. The semiconductor device of claim 5, further comprising:
a fifth doped portion having the first conductive type, coupled to each of the third doped portion and the fourth doped portion, and disposed above the fourth doped portion.

7. The semiconductor device of claim 1, further comprising:
a third converter structure configured to modulate the optical light to generate a third modulated light;
a fourth converter structure configured to modulate the third modulated light to generate a fourth modulated light; and
a third waveguide portion configured to receive each of the fourth modulated light and the second modulated light.

8. The semiconductor device of claim 7, further comprising:
a fourth waveguide portion configured to transmit the third modulated light from the third converter structure to the fourth converter structure, and elongated along the first direction,
wherein the third converter structure, the fourth waveguide portion, and the fourth converter structure are arranged along the first direction in order.

9. The semiconductor device of claim 8, further comprising:
a fifth waveguide portion configured to transmit the third modulated light from the third converter structure to the fourth converter structure, and separated from the fourth waveguide portion.

10. The semiconductor device of claim 1, further comprising:
a first converter structure group configured to modulate the optical light to generate a plurality of first modulated lights; and
a second converter structure group configured to modulate the plurality of first modulated lights to generate a third modulated light,
wherein the first converter structure is included in the first converter structure group, and
the second converter structure is included in the second converter structure group.

11. A method, comprising:
forming a substrate;
forming an oxide portion above the substrate;
forming a first doped portion, a second doped portion, a third doped portion and a fourth doped portion above the oxide portion and arranged along a first direction in order; and
forming a first waveguide portion and a second waveguide portion above the oxide portion and split from each other along the first direction,
wherein the first waveguide portion is coupled to each of the first doped portion and the second doped portion,
the second waveguide portion is coupled to each of the third doped portion and the fourth doped portion,
each of the first doped portion and the fourth doped portion has a first conductive type, and
each of the second doped portion and the third doped portion has a second conductive type different from the first conductive type.

12. The method of claim 11, further comprising:
forming a fifth doped portion between and separated from the second doped portion and the third doped portion; and
forming a silicon portion between and separated from the first waveguide portion and the second waveguide portion,
wherein the fifth doped portion contacts the silicon portion.

13. The method of claim 12, wherein the silicon portion, the first waveguide portion and the second waveguide portion are formed by the same material.

14. The method of claim 12, wherein the fifth doped portion has the second conductive type and has a first carrier density, and
each of the second doped portion and the third doped portion has a second carrier density lower than the first carrier density.

15. The method of claim 11, further comprising:
forming a fifth doped portion above the second doped portion and has the first conductive type,
wherein the fifth doped portion is coupled to each of the first doped portion and the second doped portion.

16. The method of claim 11, wherein
the first doped portion, the second doped portion, the third doped portion and the fourth doped portion are included in a first converter structure,
the first waveguide portion and the second waveguide portion are coupled between the first converter structure and a second converter structure, and
each of two opposite edges of the first waveguide portion has a length approximately equal to a distance between the first converter structure and the second converter structure.

17. The method of claim 11, wherein a distance between the first waveguide portion and the second waveguide portion is approximately equal to a distance between the second doped portion and the third doped portion.

18. A semiconductor device, comprising:
a resonator configured modulate an optical light to generate a first modulated light; and
a waveguide structure configured to transmit the optical light to the resonator, and configured to output the first modulated light,
wherein the resonator comprises:
at least one first converter structure configured to modulate the optical light to generate a second modulated light; and
at least one second converter structure configured to modulate the second modulated light to generate the first modulated light.

19. The semiconductor device of claim 18, wherein
at least one first converter structure comprises a third converter structure and a fourth converter structure,
at least one second converter structure comprises a fifth converter structure a sixth converter structure,
the third converter structure, the fourth converter structure, the fifth converter structure and the sixth converter structure are configured to modulate the optical light in order,
each of the third converter structure the fifth converter structure is elongated along a first inclined direction,
each of the fourth converter structure the sixth converter structure is elongated along a second inclined direction,
the waveguide structure is elongated along a first direction, and
the first inclined direction, the second inclined direction and the first direction are different from each other.

20. The semiconductor device of claim 18, further comprising:
a resonator group comprising a plurality of resonators,
wherein the plurality of resonators are arranged along a first direction and configured to modulate the optical light in order, and
the waveguide structure is elongated along the first direction.
